(19) United States
(12) Patent Application Publication
(10) Pub. No.: US 2010/0233430 A1
(43) Pub. Date: Sep. 16, 2010

(54) Structured component, in particular heat shield

(76) Inventor: Bruno Malinek, Langenzenn (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 12/308,392

(22) PCT Filed: Jun. 12, 2007
(86) PCT No.: PCT/EP2007/005147

§ 371 Date: Dec. 15, 2008

(30) Foreign Application Priority Data
Jun. 24, 2006 (DE) 10 2006 029 086.0

(51) Int. Cl. B32B 3/10

(52) U.S. Cl. 428/138

(57) ABSTRACT

The invention relates to a structured component, in particular heat shield, consisting of at least two layers (1, 3) that can be interconnected, one of which is designed as a cover layer (1) and at least one of which is designed as a structured layer (3). Said structured layer or layers (3) has/have a perforation (7, 13) as the first structure, which is incorporated from the opposite side of the structured layer (3) to the cover layer (1). At least one additional structure (9, 11) is situated in the structured layer (3) containing the perforation (7, 13), said additional structure projecting on the opposite side to the cover layer (1). Since the perforation (7, 13), as the first structure of the structured layer (3), leads to the environment and the additional structure (9, 11) of the structured layer (3) is completely overlapped by the cover layer (1), a person having average skill in the art can obtain, in a surprising manner, extremely effective soundproofing and excellent thermal insulation in relation to known solutions that comprise corrugated sheet metal between two sheet metal cover layers.

The invention relates to a structured component, in particular heat shield, consisting of at least two layers which can be connected to one another, and of which one is made as a cover layer and at least one is made as a structured layer, at least one structured layer as the first structure having a perforation which is made from the side of the structured layer opposite the cover layer, in the structured layer which has the perforation there being at least one other structure which projects on the side opposite the cover layer.

Structured components of a comparable type are known in various embodiments and are widely used especially in automotive engineering. As a heat shield these structured components are designed to keep the heat released from exhaust-carrying parts of internal combustion engines, turbochargers, or especially catalytic converters, by radiation and/or convection away from adjacent components or body parts. Since the parts to be shielded which are under consideration are not only heat sources, but also noise sources, in addition to heat insulation, favorable acoustic shielding behavior is also extremely important.

The known structured components often do not adequately meet these requirements. To achieve relatively good acoustic shielding behavior, in the known structured components of the aforementioned type, in the structured layer which faces the heat and noise source there is a perforation (cf. DE 40 35 177 A1), the hole diameters being selected according to the wavelengths of concern in order to achieve passability of the acoustic waves through the structured layer. As has been shown, satisfactory acoustic shielding behavior cannot be achieved with these measures. It is therefore necessary, as shown in DE 40 35 177 A 1, to provide several structured layers with acoustically active structures. This leads to a complex sandwich structure in which structured layers are interconnected by welds, rivets, or screws.

EP A 0 806 555 A1 discloses a heat shield, in particular for shielding of exhaust-carrying parts in motor vehicles, with at least one metallic insulating layer located between two cover layers, at least one insulating layer being formed by a sheet metal part which has been structured by means of a plurality of perforations, or a foil, and the burr of the perforations being slotted, serrated, or tongue-shaped. These burr parts in the known solution merely cause spot thermal contacts to adjacent layers or to the cover layers which preferably likewise consist of metal. If the burrs are advantageously bent to the outside, they cause spot doubling of the material thickness of the sheet metal part or of the foil.

DE 197 23 943 C1 likewise discloses a heat shield with an insulating layer located in the middle between two sheet metal cover layers in the form of a corrugated sheet metal with openings in the form of a perforation in both directions, that is, oriented toward the respective cover layer. In a continuation of the above described solution, some of the serrated burrs which are formed by the perforation are used to join the two sheet metal cover layers to one another, conversely the other burr parts or serrated parts extend with an intended distance between the two cover layers toward the latter without engaging them. In this way, within a shielding part smaller regions form with the indicated serrated connection and larger shielding regions form without this engagement. With respect to satisfactory acoustic shielding behavior, these known solutions still leave much to be desired.

With respect to this prior art, the object of the invention is to devise a structured component which in spite of simple design enables economical production and in addition to a good heat insulating action also enables highly effective soundproofing.

According to the invention this object is achieved by a structural component which has the features of claim 1 in its entirety.

In that, as specified in the characterizing part of claim 1, the perforation as the first structure of the structured layer ends in the exterior, and in that the remaining structure of the structured layer is overlapped by the cover layer at each point without engagement, for one with average skill in the art in this field, highly effective soundproofing with very good heat insulating action surprisingly results, compared to the known solutions with a corrugated sheet located between two cover layers of the sheet metal. The solution according to the invention as a result of the differently oriented perforations, together with the cover layer which is spaced at a distance, forms a type of resonance bottom in which the perforation oriented to the inside toward the cover layer as a first structure feeds the acoustic waves as a receiving funnel and with the corresponding refraction and respectively insulated reflects them by way of the further structure as a discharge funnel in the direction of the acoustic source to the exterior. The heat radiation which is added by way of the heat source is accordingly reflected by way of the funnel which acts in the opposite direction.

In one preferred embodiment of the structured component according to the invention, it is provided that wall sections which project at least partially between two other adjacent structures extend in the form of surface sections which are rib-shaped convexities. In this way wave crests with a straight apex line form and are used as stiffening elements of the entire structured layer, and which otherwise under vibration loading stiffen the entire shielding part in this way by damping of vibrations. Advantageously, it is furthermore provided that the respective surface sections with the same convexity height bear the other structures on their top.

In another, especially preferred embodiment of the structured component according to the invention the respective surface sections form a regular, preferably square stiffening pattern, the respective corner point being formed from another structure and at least in part each square encompassing the first structure. In this way funnels which widen to the outside are formed and end in the direction of the cover layer over the respectively first structure; this intensifies the already described funnel capture effect so that in addition to improved stiffening of the overall shield system, both acoustic as well as heat shielding are improved.

Preferably the further structure is formed from one respective depression each. Here the arrangement can be such that the depression is a closed bottom part or that the depression is formed from a second perforation, comparably to the first structure, as is especially advantageous with respect to the soundproofing behavior.

Preferably the second perforation is made from the side facing the cover layer, so that the second perforation with its wall parts which project over the plane of the structured layer forms the respective depression. This also applies to the first perforation which is made from the side opposite the cover layer so that the wall parts projecting over the plane of the structured layer also form the respective depression here which projects out of the plane of the structured layer on the side facing the cover layer.

The arrangement can be such that the first and second perforation are arranged in a pattern in which along straight lines which are at a right angle to one another there are a first perforation and a second perforation alternating with one another and spaced apart from one another with uniform distances.

For perforations located at uniform distance from one another the rib-like surface section can delimit square surface regions on the structured layer.

In embodiments in which the structured layer as a further structure has a wave-like convexity with a large area, with a suitable choice of the shape of the convexity adapted to the acoustic waves under consideration, a further improvement of the acoustic insulating action can be achieved.

With very low production effort a reliable bond between the cover layer and structured layer is possible when the cover layer forms an edge-side bead of the structured layer.

For especially advantageous embodiments in which there is an insulating layer between the metallic cover layer and the metallic structured layer, the thermal and acoustic insulating action is especially good.

The invention is detailed below using the drawings:

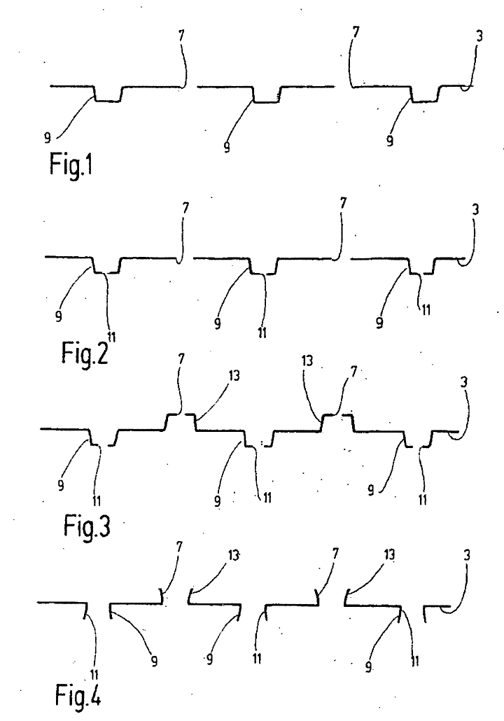

FIG. 1 shows a simplified diagram of only one longitudinal section of the structured layer of one embodiment of the structured component according to the invention, the first structure and the second structure on the structured layer being shown exaggerated to illustrate the basic principle of the invention;

FIGS. 2 to 4 show diagrams similar to FIG. 1 for illustration of a second (FIG. 2) and a third (FIGS. 3 and 4) embodiment of the invention;

FIG. 5 shows a broken partial plan view, looking at the side of the third embodiment facing away from the cover layer, which is shown enlarged approximately 6-fold compared to a practical embodiment;

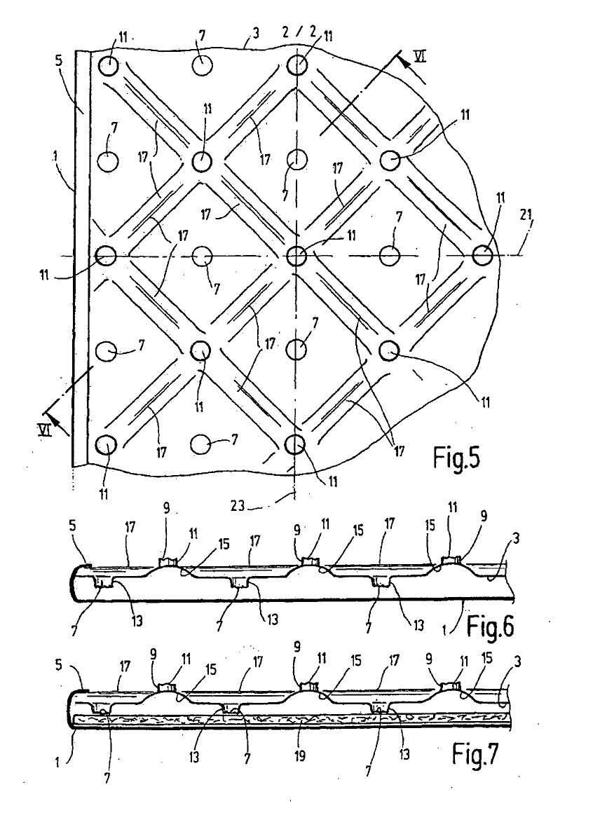

FIG. 6 shows a section according to cutting line VI-VI from FIG. 5, and

FIG. 7 shows a section of another embodiment of the invention similar to FIG. 6.

All the embodiments of the invention which are shown in the figures consist of a cover layer 1 which is partially visible only in FIGS. 5 to 7, and of a structured layer which is designated as reference number 3 in all figures, regardless of the fact that it is made differently in the individual embodiments. The cover layer 1 is free of openings and finer structuring, aside from fastening holes which may be present for attachments, and can be largely flat or can be provided with curves. The cover layer 1 is produced in one piece from high-grade steel sheet and its dimensions and outline are matched to the components to be shielded. The structured layer 3 is likewise formed in one piece from a high-grade steel sheet and shaped accordingly to form the structures explained below, the outline of the structured layer 3 being matched to the outline of the cover layer 1 when the structured layer 3 and the cover layer 1 are placed against one another, the latter with a flanged edge 5 projects over the edge of the structured layer 3 and the layers 1 and 3 are connected to one another by folding over the flanged edge 5, see in particular FIGS. 6 and 7.

FIG. 1 shows the execution of the structured layer 3 in a first embodiment. In FIG. 1, as in FIGS. 2 to 4, the structured layer 3 is shown in an orientation in which the side which is at the top in the drawings is facing the cover layer 1 which is not shown and the side of the structured layer 3 which is at the bottom in FIGS. 1 to 4 is facing the noise and heat source (not shown). In the example from FIG. 1 the structured layer 3 as the first structure has a perforation, of which the figures show only perforation holes 7. The holes 7 which form these perforations are cut into the structured layer 3 from the side opposite the cover layer 1, that is, from the side facing the noise and heat source. As a further structure the structured layer 3 of the embodiment from FIG. 1 has the respective depression 9, these depressions 9 being impressed from the side facing the cover layer 1, so that the depressions 9 project on the side of the structured layer 3 opposite the cover layer 1.

The embodiment shown in FIG. 2 differs from the first described example in that the structured layer 3 has not only perforation holes 7 and depressions 9 which project on the side opposite the cover layer 1, but that the depressions 9 do not have a closed bottom part, but instead form a second perforation with holes 11 in the bottom part. In production, the second perforation which has the holes 11 is formed such that the structured layer 3 is penetrated from the side which lies at the top in the drawings, as a result of which at the same time the depressions 9 and their perforation (holes 11) are produced.

FIG. 3 illustrates one version of the example from FIG. 2, its being shown that in production not only are the depressions 9 produced as elements of the second perforation with perforation holes 11 by cutting from the top, but that the holes 7 of the first perforation are also produced by cutting, in this case from the side facing the noise and heat source such that depressions 13 are formed which project against the cover layer 1.

FIG. 4 illustrates, in a form less diagrammatically simplified than in the previous figures, the shape which results by puncturing the structured layer 3 from one side and the other, that specifically when the first perforation with holes 7 and the second perforation with holes 11 are formed, the wall parts of the first and second perforation, which parts are deformed in puncturing, form the depressions 13 and 9 which project toward the cover layer 1 and toward the noise and heat source.

FIGS. 5 to 7 illustrate the corresponding practical embodiments. As a comparison of FIGS. 5 and 6 shows, the structured layer 3 is formed according to the schematic from FIG. 4 such that in a single production step, when the first perforation with the holes 7 is formed in the structured layer 3, the depressions 13 are produced and when the second perforation with the holes 11 is formed, the depressions 9 are produced. As FIGS. 6 and 7 show, when the holes 7 and 11 are punched, serrated hole edges form as end edges of the depressions 9 and 13 which constitute an additional microstructure on either side of the structured layer 3. As FIGS. 6 and 7 likewise show, when the structured layer 3 is punched from the side facing the cover layer 1, convexities 15 are formed, in whose apex region depressions 9 with holes 11 are located. This configuration on the side of the structured layer 3 facing the noise and heat source yields rib-like, projecting surface sections which extend between the holes 11 in the form of elongated wave crests 17 which form a structured reinforcement, for example, against vibration loads.

FIGS. 6 and 7 shows the side of the structured layer 3 facing the cover layer 1 without these convexities, i.e., the depressions 13 with the holes 11 directly adjoin the primary plane of the structured layer 3. This side of the structured layer 3 could, however, likewise be provided with convexities which correspond to the convexities 15 so that on this side of the structured layer 3 between the depressions 7 surface sections which project as ribs would form corresponding to the wave crests 17. For one embodiment which is not detailed, the free ends of the depressions 13 can also touch the cover layer 1 in order in this way to directly discharge the noise and heat. In turn a perforation or hole which is not shown can be made in the cover layer 1. The depressions which are to be produced can have wall sections which are closed in themselves, as is shown in particular in FIGS. 6 and 7; but it is also possible to divide the respective encompassing edge of the depression 7 into segments which, when bent down with their free edge (cf. FIG. 4), result in a serrated or tongue-shaped arrangement, as are shown, for example, in EP 0 806 555 A1 of the applicant.

In the embodiment shown in FIG. 7, in the intermediate space between the structured layer 3 and the cover layer 1, there is an additional insulating layer 19 of high temperature-resistant insulating material which improves the acoustic and thermal insulating action.

As is especially apparent from FIG. 5, the first perforation with holes 7 and the second perforation with holes 11 are arranged in a pattern in which along straight lines which are at a right angle to one another and which are designated as 21 and 23 in FIG. 5, the first and the second perforation are arranged in alternation with one another and with respectively identical distances from one another. The structured layer 3 thus forms a regular structured pattern in which the rib-like surface sections which form the wave crests 17 border square surface regions on the structured layer 3.

FIG. 5 shows the structuring pattern compared to a practical embodiment in a 6× enlargement. In an example that is advantageous with respect to acoustic insulating action, the hole diameter of the perforations can be in the range of one millimeter, and the distances between adjacent holes 7 and 11 can be approximately 5 mm.

The figures show the cover layer 1 and the structured layer 3 for the most part flat. But there can also be a convexity which is in the shape of a wave over a large area on the structured layer 3, and the dimensioning and wave shape can be chosen such that at the pertinent acoustic frequencies there is an additional improvement of the acoustic insulating action.

1. A structured component, in particular heat shield, consisting of at least two layers (1, 3) which can be connected to one another, and of which one is made as a cover layer (1) and at least one is made as a structured layer (3), at least one structured layer (3) as the first structure having a perforation (7, 13) which is made from the side of the structured layer (3) opposite the cover layer (1), in the structured layer (3) having the perforation (7, 13) there being at least one further structure (9, 11) which projects on the side opposite the cover layer (1), characterized in that the perforation (7, 13) as the first structure of the structured layer (3) ends in the exterior and that the further structure (9, 11) of the structured layer (3) is overlapped by the cover layer (1) at each point without engagement.

2. The structured component according to claim 1, characterized in that wall sections which project at least partially between two other adjacent structures (9, 11) extend as surface sections (17) which are rib-shaped convexities.

3. The structured component according to claim 1, characterized in that the respective surface sections (17) with the same convexity height bear the further structures (9, 11) on their top.

4. The structured component according to claim 1, characterized in that the respective surface sections (17) form a regular, preferably square stiffening pattern.

5. The structured component according to claim 1, characterized in that the stiffening pattern forms regular quadrilaterals in which the respective corner point is formed from a further structure (9, 11), and that each quadrilateral encompasses the first structure (7, 13) at least partially.

6. The structured component according to claim 5, characterized in that the first structure with the first perforation (7, 13) is located in the middle in the assignable quadrilateral on rib-like surface sections (17).

7. The structured component according to claim 1, characterized in that the first (7, 13) and second perforation (9, 11) are arranged in a pattern in which along straight lines (21, 23) which are at a right angle to one another, there are a first perforation (7, 13) and a second perforation (9, 11) alternating with one another and spaced apart from one another with the same distances.

8. The structured component according to claim 1, characterized in that the further structure is formed from one respective depression (9) each.

9. The structured component according to claim 8, characterized in that the depression (9) is a closed bottom part or is formed from a second perforation (9, 11), comparably to the first structure (7, 13).

10. The structured component according to claim 9, characterized in that the second perforation (9, 11) as well as the first perforation (7, 13) with their wall parts (9, 13) which project over the plane of the structured layer (3) form the respective depression.

11. The structured component according to claim 1, characterized in that the structured layer (3) as a further structure has a large-area, wave-like convexity.

12. The structured component according to claim 1, characterized in that the cover layer (1) forms an edge-side bead (5) of the structured layer (3).

13. The structured component according to claim 1, characterized in that there is an insulating layer (19) between the metallic cover layer (1) and the metallic structured layer (3).
